(19) United States
(12) Patent Application Publication
(10) Pub. No.: US 2014/0325201 A1
(43) Pub. Date: Oct. 30, 2014

(54) AUTOMATIC ENTRANCE DEVICE AND METHOD FOR UPGRADE BOOT MODE

(71) Applicant: CORE LOGIC INC., Seoul (KR)

(72) Inventor: KWONWOO NAM, Anyang-si (KR)

(73) Assignee: CORE LOGIC INC., Seoul (KR)

(21) Appl. No.: 14/259,356

(22) Filed: Apr. 23, 2014

(30) Foreign Application Priority Data
Apr. 26, 2013 (KR) 10-2013-0046894

(51) Int. Cl. G06F 9/44; G06F 9/445

(52) U.S. Cl. CPC G06F 9/4401; G06F 8/665
USPC 713/2

(57) ABSTRACT

An automatic entrance device in accordance with the present invention performs software upgrade by starting up a terminal in an upgrade boot mode by holding operation of a memory when a USB interface of a terminal is connected to an external device, and starts up the terminal in a normal boot mode by a processor accessing memory by disabling hold of operation of memory when the USB interface and external device are disconnected.

### CROSS-REFERENCE TO RELATED APPLICATION

This application claims priority to Korean Patent Application No. 10-2013-0046894 filed on 26 Apr., 2013, and all the benefits accruing therefrom under 35 U.S.C. §119, the contents of which is incorporated by reference in its entirety.

### BACKGROUND

1. Technical Field

Embodiments of the present invention relates to an automatic entrance device and method for upgrade boot mode when a terminal starts up.

2. Description of the Related Art

A terminals starts to operate by processors reading startup software, that is startup data, stored in a SPI flash memory. This is called a normal boot mode.

In special cases, for example, when a terminal is connected to computers, etc. to upgrade startup data, a terminal should operate in an upgrade boot mode.

But, if startup data is already stored in a SPI flash memory, a processor reads stored startup data in a SPI flash memory in highest order of priority. Therefore, a terminal operates in a normal boot mode not an upgrade boot mode, and thus making upgrade of startup data impossible.

### BRIEF SUMMARY

An embodiment of the present invention provides an automatic entrance device and method for upgrade boot mode that allows terminal to automatically enter an upgrade boot mode by holding operation of a SPI flash memory.

An embodiment of the present invention provides an automatic entrance device and method for upgrade boot mode that allows upgrading startup software through a USB interface by automatically starting up in an upgrade boot mode when a terminal starts up while connected to a USB.

An automatic entrance device for upgrade boot mode in accordance with an embodiment of the present invention comprises: a connection determining unit determining whether a terminal and an external device are connected; and a boot mode control unit allowing the terminal to startup in a normal startup mode or an upgrade startup mode by granting or blocking memory access of the terminal according to whether a terminal and an external device are connected, and the terminal performs upgrade of startup software stored in a memory of the terminal by downloading upgrade data from the external device when the terminal starts up in the upgrade boot mode by the boot mode control unit.

The boot mode control unit controls the terminal to startup in the upgrade boot mode when the terminal is connected to the external device, and may control the terminal to startup in the normal boot mode when the terminal is disconnected from the external device.

The terminal is connected to the external device through a USB interface, and the connection determining unit may determine whether the terminal and the external device are connected based on bus voltage (VBUS) levels of a USB connector of the terminal.

The boot mode control unit comprises one or more mono-stable multivibrators, and the mono-stable multivibrator may start up the terminal in the upgrade boot mode by holding operation of the memory or starts up the terminal in the normal boot mode by disabling hold of operation of the memory according to whether the terminal and the external device connected.

The boot mode control unit may further comprise one or more resistors and condensers determining output maintaining time of the mono-stable multivibrators.

An automatic entrance device for upgrade boot mode in accordance with the present invention may further comprise a processor executing the startup software stored in the memory or executing an upgraded startup software according to control of the boot mode control unit

An automatic entrance method for upgrade boot mode in accordance with the present invention comprises: determining whether a terminal and an external device are connected; starting up the terminal in an upgrade boot mode by blocking memory access of the terminal when the terminal and the external device are connected from the determination result; and performing upgrade of startup software stored in a memory of the terminal by downloading upgrade data from the external device when the terminal starts up in the upgrade boot mode.

The determining whether connected step may comprise determining whether the terminal and the external device are connected based on bus voltage (VBUS) levels of a USB connector of the terminal.

The starting up in the upgrade boot mode step may comprise starting up the terminal in the upgrade boot mode by holding operation of the memory by using one or more mono-stable multivibrators.

An automatic entrance method for upgrade boot mode in accordance with the present invention may further comprise: starting up the terminal in a normal boot mode by allowing memory access of the terminal when the terminal and the external device is disconnected from the determination result; and reading and executing stored data in the memory when the terminal starts up in the normal boot mode.

The starting up in the normal boot mode step may comprise starting up the terminal in the normal boot mode by disabling hold of operation of the memory by using one or more mono-stable multivibrators.

An automatic entrance method for upgrade boot mode in accordance with the present invention may further comprise: determining whether the terminal and the external device are connected when the software upgrade is completed; and starting up in a normal boot mode by rebooting the terminal when the terminal is connected to the external device.

In accordance with an embodiment of the present invention, by making automatic entrance into upgrade boot mode possible by holding flash memory by using mono-stable multivibrators, user inconvenience may be reduced, and may prevent errors that may occur from incorrect operation.

Also, in accordance with an embodiment of the present invention, startup software may be upgraded through USB interface by automatically starting up in an upgrade boot mode when a terminal starts up when USB is connected.

### BRIEF DESCRIPTION OF THE DRAWINGS

FIG. 1 is a schematic drawing of an automatic entrance device for upgrade boot mode in accordance with an embodiment of the present invention.

FIG. 2 is a circuit diagram of an automatic entrance device for upgrade boot mode in accordance with an embodiment of the present invention.

FIG. 3 is a drawing showing waveforms of signals during upgrade boot mode start up in accordance with an embodiment of the present invention.

FIG. 4 is a drawing showing waveforms of signals during normal boot mode start up in accordance with an embodiment of the present invention.

FIG. 5 is a block diagram illustrated to describe an automatic entrance device for upgrade boot mode in accordance with an embodiment of the present invention.

FIG. 6 is a flow chart illustrated to describe an automatic entrance device for upgrade boot mode in accordance with an embodiment of the present invention.

### DETAILED DESCRIPTION

Advantages and features of the present invention, and method for achieving thereof will be apparent with reference to the accompanying figures and detailed description that follows. But, it should be understood that the present invention is not limited to the following embodiments and may be embodied in different ways, and that the embodiments are given to provide complete disclosure of the invention and to provide thorough understanding of the invention to those skilled in the art, and the scope of the invention is limited only by the accompanying claims and equivalents thereof. Like components will be denoted by like reference numerals throughout the specification.

Hereinafter, embodiments of the invention will be described in detail with reference to accompanying drawings.

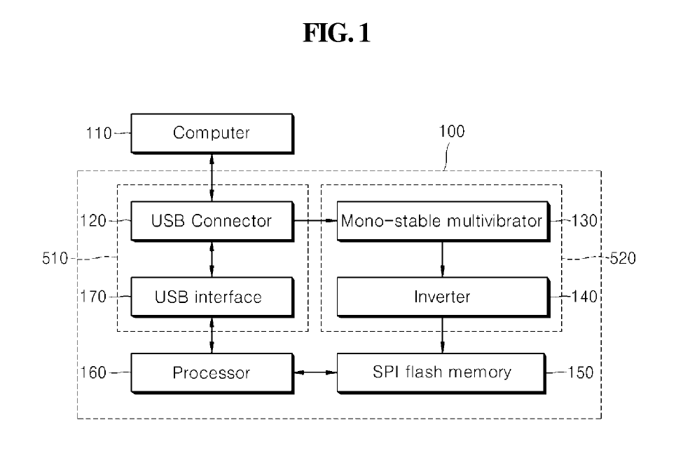

FIG. 1 is a schematic drawing of an automatic entrance device for upgrade boot mode in accordance with an embodiment of the present invention.

Here, the automatic entrance device for upgrade boot mode may be realized by being installed in a terminal.

For reference, the terminal may be understood as a concept comprising devices that reads startup software from memory such as flash memory, SD card (Secure Digital Card), EEPROM (Electrically Erasable Programmable ROM), etc., starts up, and upgrades the startup software through USB interface.

It is described in the present embodiment by limiting installed memory to the terminal to a SPI flash memory, which is a nonvolatile memory. This is for convenience and ease of description and is not to limit the scope of the present invention.

As illustrated in FIG. 1, an automatic entrance device (100) for upgrade boot mode in accordance with an embodiment of the present invention makes the terminal to automatically enter an upgrade boot mode possible by a processor (160) controlling operation of reading startup software from a SPI flash memory (150).

For this, an automatic entrance device (100) for upgrade boot mode in accordance with an embodiment may comprise a mono-stable multivibrator (130). The mono-stable multivibrator (130) determines whether access to a SPI flash memory (150) is possible according to an output signal from a USB connector (120).

That is, the mono-stable multivibrator outputs a high or a low pulse signal when a rising edge or a falling edge is input from the USB connector (120). This output signal of a mono-stable multivibrator is input to the SPI flash memory (150) inverted by an inverter (140). The SPI flash memory becomes a hold state or hold disabled state according to an output signal of the inverter (140).

As such, the SPI flash memory may become a hold state or hold disabled state according to an output signal (inverted signal) of the inverter (140). In this case, the inverter (140) is required. But, the SPI flash memory (150) may be held or hold disabled by directly receiving an output signal of the mono-stable multivibrator. The inverter (130) is not required in this case.

The processor (160), when the SPI flash memory (150) is in a hold state, performs software upgrade by starting up a terminal in an upgrade boot mode, downloading data (startup software) for software upgrade through a USB interface (170), and storing it in the SPI flash memory (150).

The processor (160), when the SPI flash memory (150) is in a hold disabled state, starts up a terminal in a normal boot mode, accesses the SPI flash memory (150), and reads and executes the startup software stored in the SPI flash memory (150).

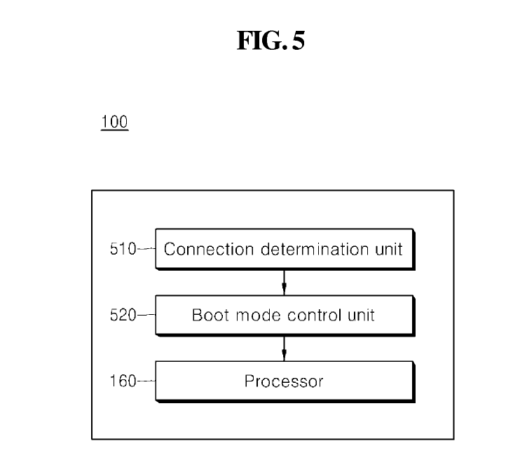

For reference, in FIG. 1, drawing symbol 510 indicates a connection determination unit of FIG. 5, and drawing symbol 520 indicates a boot mode control unit of FIG. 5. That is, the connection determination unit (510) comprises the USB connector (120) and the USB interface (170), and the boot mode control unit (520) may comprise the mono-stable multivibrator (130) and an inverter (140).

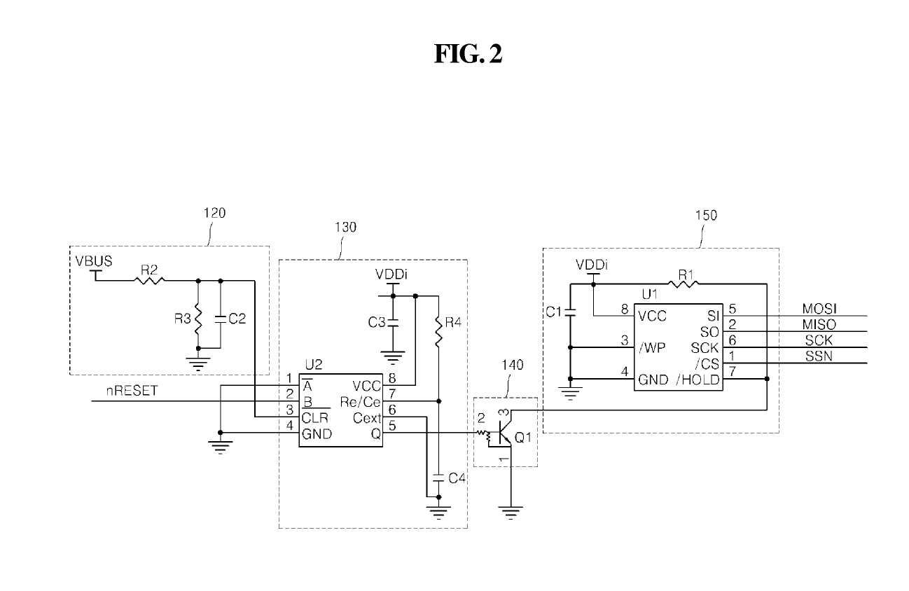

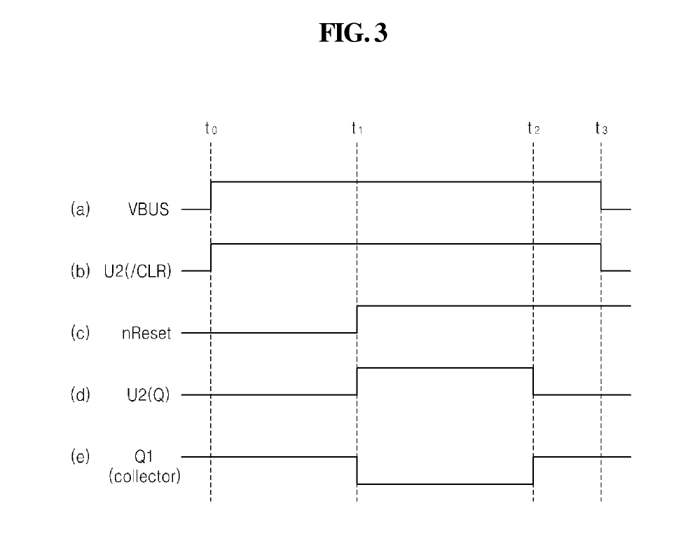

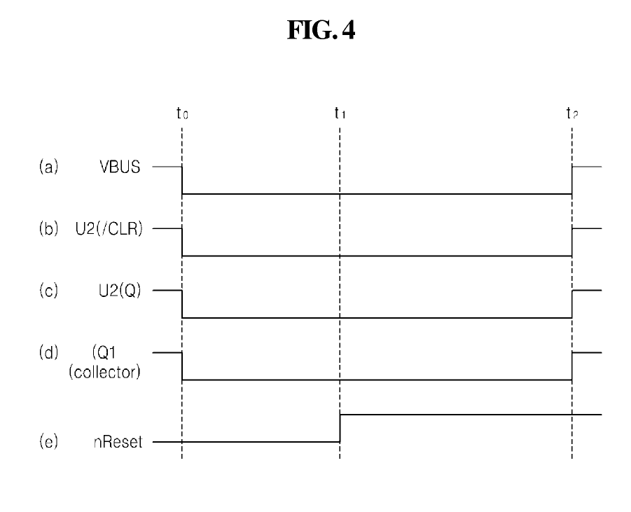

FIG. 2 is a circuit diagram of an automatic entrance device for upgrade boot mode in accordance with an embodiment of the present invention. And, FIG. 3 is a drawing showing waveforms of signals during upgrade boot mode start up in accordance with an embodiment of the present invention. FIG. 4 is a drawing showing waveforms of signals during normal boot mode start up in accordance with an embodiment of the present invention.

First, referring to FIG. 2 and FIG. 3, a high level voltage of 5V is inputted at time axis (t₀˜t₃) in VBUS as in (a) of FIG. 3 when a terminal is connected to a USB host (computer), an input (/CLR) of U2 of a mono-stable multivibrator (130) becomes high at time axis (t₀˜t₃) as in (b) of FIG. 3. Here, R2, R3, C3 of a USB connector (120) takes the role of lowering and matching operating voltage of U2 by dividing VBUS, which is 5V.

Therefore, nRESET becomes high from low at time axis (t₁) as in (c) of FIG. 3, and thus a rising edge is input in input (B) of the U2 when the terminal starts up. Then, output (Q) of the U2 becomes high from low at time axis (t₁˜t₂) as in (d) of FIG. 3.

Here, nRESET is a reset signal of a processor. The processor is in a RESET (system stop and initialization) state when nRESET is low, and in a normal state when nRESET is high.

In this instance, a time of a signal of an output (Q) of the U2 is maintained high is determined by values of R4 and C4 of a mono-stable multivibrator (130). This is a characteristic of operation of a mono-stable multivibrator (130), and a mono-stable multivibrator (130) stays at a non stable state during a time of a signal of output (Q) of U2 is maintained high, and returns to a stable state after that time.

Therefore, an automatic entrance device (100) for upgrade boot mode in accordance with the present embodiment may automatically start up a terminal in an upgrade boot mode after the described time even when a terminal and a computer are not disconnected by USB.

For reference, VDDi connected to VCC of the U2 is a power source for a mono-stable multivibrator (130), and C3 is a bypass condenser for power stabilization.

When an output (Q) of the U2 is high, Q1 (140) becomes an ON state, and thus a collector of the Q1 (140) becomes low at time axis (t₁˜t₂) as in (e) in FIG. 3. Here, the Q1 (140) is an inverter taking the role of inverting output of the U2 (140), and as an example in the present embodiment, BJT (Bipolar Junction Transistor) is used.

When a collector of the Q1 (140) is low, a low level pulse signal is input in input (/HOLD) of U1 of SPI flash memory (150) and the U1 becomes a hold state. Therefore, a processor cannot access the U1 and cannot read data from the U1, and thus the terminal fails to startup in a normal boot mode and starts up in an upgrade boot mode.

Next, referring to FIG. 2 and FIG. 4, when the terminal and the USB host (computer) disconnects, the VBUS becomes low at time axis (t₀˜t₂) as in (a) of FIG. 4, and an input (/CLR) of U2 of a mono-stable multivibrator becomes low at time axis (t₀˜t₂) as in (b) of FIG. 4.

Therefore, an output (Q) of the U2 is always low in time axis (t₀˜t₂) and as in (c) of FIGS. 4, and Q1 (140) is always low, that is maintaining an OFF state, at time axis (t₀˜t₂) as in (d) of FIG. 4. And then, a high level pulse signal is input in an input (/HOLD) of U1 of SPI flash memory (150) and the U1 becomes a hold disable state. And then, when nRESET becomes high from low at time axis (t₀˜t₂) as in (e) in FIG. 4, a processor accesses the U1, reads data from the U1, and starts up in a normal boot mode.

FIG. 5 is a block diagram illustrated to describe an automatic entrance device for upgrade boot mode in accordance with an embodiment of the present invention.

Referring to FIG. 1 and FIG. 5, an automatic entrance device (100) for upgrade boot mode in accordance with an embodiment of the present invention comprises a connection determination unit (510), a boot mode control unit (520), and a processor (160).

The connection determination unit (510) determines whether a terminal and an external device (computer (110)) are connected through an USB interface (170) of the terminal. In this instance, the connection determination unit (510) may be realized by a USB connector (120) and a USB interface (170). The connection determination unit (510) may determine whether the terminal and the computer (110) are connected based on bus voltage (VBUS) levels of the USB connector (120).

That is, the connection determination unit (510) may determine that a USB connection between the terminal and the computer (110) is made when a high level voltage is input in a VBUS of the USB connector (120). On the contrary, the connection determination unit (510) may determine that a USB connection between the terminal and the computer (110) is not made when a low level voltage is input in a VBUS of the USB connector (120).

The boot mode control unit (520) grants or blocks access to a SPI flash memory (150) of the terminal according to whether the terminal and the computer (110) are connected, and controls the boot mode of the terminal so that the terminal starts up in a normal boot mode or an upgrade boot mode.

That is, the boot mode control unit (520), when the terminal is connected to the computer (110), grants access to a SPI flash memory (150) of the terminal and may allow the terminal to start up in the upgrade boot mode. Also, the boot mode control unit (520), when the terminal is disconnected to the computer (110), blocks access of the terminal to a SPI flash memory (150) and allow the terminal to start up in the normal boot mode.

The boot mode control unit (520) of the present embodiment may comprise one or more mono-stable multivibrators (130) and an inverter (140)

The mono-stable multivibrator (130), when the terminal is connected to the computer (110), receives input of a high level voltage from a bus voltage (VBUS) of the USB connector (120) and may output a high level pulse signal.

The inverter (140) inverts (low level pulse signal) an output signal of the mono-stable multivibrator (130) and transmits to the SPI flash memory (150). Therefore, the SPI flash memory (150) becomes a hold state.

As such, the SPI flash memory (150) may be held or hold disabled by an output signal (inverted signal) of the inverter (140). In this case, the inverter (140) is required. But, the SPI flash memory (150) may be held or hold disabled by directly receiving an output signal of the mono-stable multivibrator (130). In this case, the inverter (140) is not required.

When the SPI flash memory (150) becomes a hold state, the processor (160) cannot access the SPI flash memory (150) and cannot read data (startup software) from the SPI flash memory (150). Therefore, the processor (160) starts up the terminal in an upgrade boot mode and downloads data (upgrade data) for software upgrade through the USB interface (170) and performs upgrade of startup software stored in the SPI flash memory (150).

The mono-stable multivibrator (130), when the terminal is disconnected from the computer (110), receives input of a low level voltage from a bus voltage (VBUS) of the USB connector (120) and may output a low level pulse signal. The SPI flash memory (150) is in a hold disabled state according to on output of the mono-stable multivibrator (130).

When the SPI flash memory (150) becomes a hold disabled state, the processor (160) accesses the SPI flash memory (150) and is able to read upgrade data (startup software) from the SPI flash memory (150). Therefore, the processor (160) starts up the terminal in a normal boot mode and reads and executes upgraded data stored in the SPI flash memory (150).

The mono-stable multivibrator (130) may be realized in a form of a chip, and may comprise a resistor and a condenser (refer to “R4”, “C4” in FIG. 2) for determining maintaining time of an output signal. That is, the mono-stable multivibrator (130) may determine an output maintaining time by using a resistor and a condenser.

An automatic entrance device (100) for upgrade boot mode in accordance with the present embodiment, when the terminal that is in an off state is USB connected to the computer (110), may perform software upgrade by turning on the power of the terminal and then starting up in the upgrade boot mode. But, the automatic entrance device (100) for upgrade boot mode, when the terminal that is in a start up state is USB connected to the computer (110), may perform software upgrade by rebooting the terminal and then starting up in the upgrade boot mode.

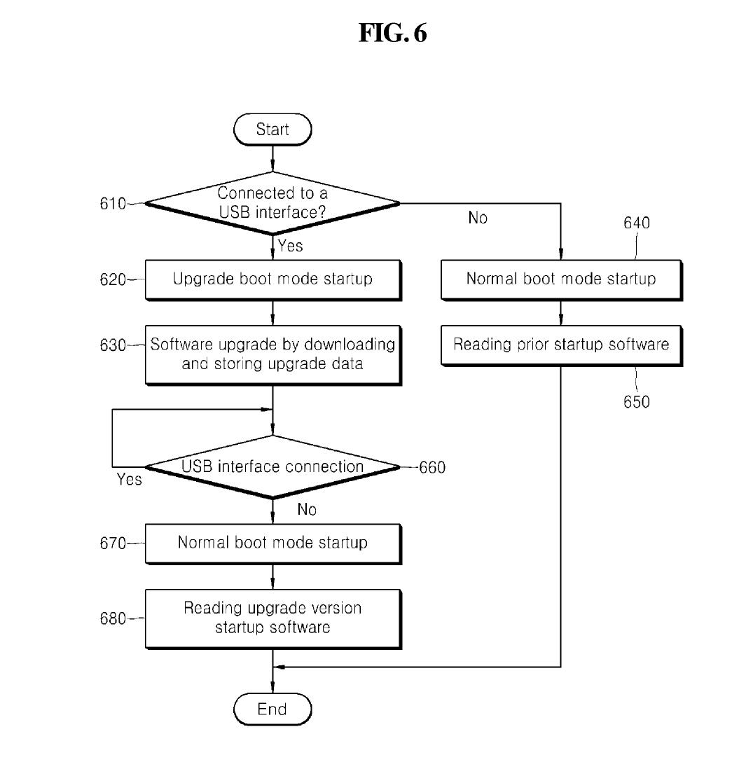

FIG. 6 is a flow chart illustrated to describe an automatic entrance device for upgrade boot mode in accordance with an embodiment of the present invention.

Referring to FIG. 1 to FIG. 6, in step (610), the automatic entrance device (100) for upgrade boot mode determines whether a USB interface (170) of a terminal is connected to a computer (110). In this instance, the automatic entrance device (100) for upgrade boot mode may determine whether a USB connection is made between the terminal and the computer (110) by using a bus voltage (VBUS) of a USB connector (120).

From the determination result, when a USB interface (170) is connected to the computer (110) (“Yes” direction in 610), in step (620), the automatic entrance device (100) for upgrade boot mode starts up the boot mode of the terminal in a upgrade boot mode according to a high level output signal of a mono-stable multivibrator.

Next, in step (630), the automatic entrance device (100) for upgrade boot mode performs upgrade of a startup software stored in a SPI flash memory (150) by downloading upgrade data from the computer (110) through the USB interface (170).

Whereas, from the determination result, when USB interface (170) is disconnected from the computer (110) (“No” direction in 610), in step (640), the automatic entrance device (100) for upgrade boot mode starts up the boot mode of the terminal in a normal boot mode according to a low level output signal of a mono-stable multivibrator.

Next, in step (650), the automatic entrance device (100) for upgrade boot mode may boot the terminal normally by allowing a processor to read and execute data (prior startup software) stored in a SPI flash memory (150).

Meanwhile, after the step (630) is performed, in step (660), the automatic entrance device (100) for upgrade boot mode may determine whether a USB interface (170) of the terminal and the computer (110) are connected.

From the determination result, when USB interface (170) of the terminal is connected to the computer (110) (“Yes” direction in 660), the automatic entrance device (100) for upgrade boot mode may stand by until the USB interface (170) is disconnected from the computer (110).

In this instance, the automatic entrance device (100) for upgrade boot mode may start up the terminal in the normal boot mode by rebooting the terminal. That is, the automatic entrance device (100) for upgrade boot mode, after software upgrade is completed, and when the USB interface (170) and the computer (110) are connected, reboots the terminal and startup in the normal boot mode.

For this, the automatic entrance device (100) for upgrade boot mode uses the mono-stable multivibrator (130) and may start up the terminal in a normal boot mode even before the USB interface (170) and the computer (110) are disconnected.

The mono-stable multivibrator (130) has characteristics of maintaining a non stable state for a fixed time when receiving a high signal and then coming back to a stable state.

That is, the mono-stable multivibrator (130) outputs high signal (non stable state) for a fixed time by receiving a high signal and then outputs a low signal (stable state) again.

In the present embodiment, by using this mono-stable multivibrator (130), even when the USB interface (170) and the computer (110) is disconnected, the terminal may start up in a normal boot mode by disabling hold on the SPI flash memory (150) according to a low level output signal of the mono-stable multivibrator (130) after a fixed time (output maintaining time of a high signal).

Meanwhile, from the determination result, when a USB interface (170) of the terminal is disconnected from the computer (110) (“No” direction of 660), in step (670), the automatic entrance device (100) for upgrade boot mode starts up a boot up of the terminal in a normal boot mode according to a high level signal of the mono-stable multivibrator.

Next, in step (680), the automatic entrance device (100) for upgrade boot mode may boot the terminal normally by allowing the processor (160) to read and execute upgrade data (upgrade version of a startup software) stored in the SPI flash memory (150).

As such, in an embodiment of the present invention, by using the mono-stable multivibrator, when the terminal starts up in a USB connected state, allows to automatically enter to an upgrade boot mode by holding the SPI flash memory.

Therefore, in accordance with an embodiment of the present invention, user inconvenience may be reduced by automatically upgrading startup software, and may prevent errors that may occur from incorrect operation.

Embodiments of the present invention comprise computer readable media comprising program commands for performing operations realized by a variety of computers. The computer readable media may comprise program commands, local data files, local data structures, etc. individually or in combination. The media may be configured or designed specifically for the present invention or may be known to those skilled in the arts and usable. Examples of computer readable recording media may comprise magnetic media such as hard disk, floppy disk, and magnetic tape, optical recording media such as CD-ROM and DVD, magneto-optical media such as floptical disk, and hardware device specifically configured to store and perform program commands such as ROM, RAM, flash memory, etc. Examples for program commands comprise not only machine language such as those made from compilers but also high level language codes that may be executed by computers by using interpreters, etc.

Although detailed embodiments in accordance with the present invention have been described herein, it should be understood that various modifications, variations and alterations can be made without deuniting from the spirit and scope of the invention. Therefore, the scope of the present invention should not be limited to the described embodiments, and should be defined by the appended claims and equivalents thereof.

What is claimed is:

1. An automatic entrance device for upgrade boot mode comprising:
a connection determining unit determining whether a terminal and an external device are connected; and
a boot mode control unit allowing the terminal to startup in a normal boot mode or an upgrade boot mode by granting or blocking memory access of the terminal according to whether a terminal and an external device are connected, and
the terminal performing upgrade of startup software stored in a memory of the terminal by downloading upgrade data from the external device when the terminal starts up in the upgrade boot mode by the boot mode control unit.

2. An automatic entrance device for upgrade boot mode according to claim 1, wherein the boot mode control unit controls the terminal to startup in the upgrade boot mode when the terminal is connected to the external device, and controls the terminal to startup in the normal boot mode when the terminal is disconnected from the external device.

3. An automatic entrance device for upgrade boot mode according to claim 1, wherein the terminal is connected to the external device through a USB interface, and the connection determining unit determines whether the terminal and the external device are connected based on bus voltage (VBUS) levels of a USB connector of the terminal.

4. An automatic entrance device for upgrade boot mode according to claim 1, wherein the boot mode control unit comprises one or more mono-stable multivibrators, and the mono-stable multivibrator starts up the terminal in the upgrade boot mode by holding operation of the memory or starts up the terminal in the normal boot mode by disabling hold of operation of the memory according to whether the terminal and the external device are connected.

5. An automatic entrance device for upgrade boot mode according to claim 4, wherein the boot mode control unit further comprises one or more resistors and condensers determining output maintaining time of the mono-stable multivibrators.

6. An automatic entrance device for upgrade boot mode according to claim 1, further comprising a processor executing the startup software stored in the memory or executing upgraded startup software according to control of the boot mode control unit.

7. An automatic entrance method for upgrade boot mode comprising:
determining whether a terminal and an external device are connected;
starting up the terminal in an upgrade boot mode by blocking memory access of the terminal when the terminal and the external device are connected from the determination result; and
performing upgrade of startup software stored in a memory of the terminal by downloading upgrade data from the external device when the terminal starts up in the upgrade boot mode.

8. An automatic entrance method for upgrade boot mode according to claim 7, wherein the determining whether connected step comprises determining whether the terminal and the external device are connected based on bus voltage (VBUS) levels of a USB connector of the terminal.

9. An automatic entrance method for upgrade boot mode according to claim 7, wherein the starting up in the upgrade boot mode step comprises, starting up the terminal in the upgrade boot mode by holding operation of the memory by using one or more mono-stable multivibrators.

10. An automatic entrance method for upgrade boot mode according to claim 7, further comprising:
starting up the terminal in a normal boot mode by allowing memory access of the terminal when the terminal and the external device is disconnected from the determination result; and
reading and executing stored data in the memory when the terminal starts up in the normal boot mode.

11. An automatic entrance method for upgrade boot mode according to claim 10, wherein the starting up in the normal boot mode step comprises starting up the terminal in the normal boot mode by disabling hold of operation of the memory by using one or more mono-stable multivibrators.

12. An automatic entrance method for upgrade boot mode according to claim 7, further comprising,
determining whether the terminal and the external device are connected when the software upgrade is completed; and
starting up in a normal boot mode by rebooting the terminal when the terminal is connected to the external device.
